(19) United States
(12) Patent Application Publication
(10) Pub. No.: US 2022/0067509 A1
(43) Pub. Date: Mar. 3, 2022

(54) SYSTEM AND METHOD FOR LEARNING FROM PARTIAL COMPRESSED REPRESENTATION

(71) Applicant: ALIBABA GROUP HOLDING LIMITED, George Town (KY)

(72) Inventors: Minghai QIN, San Mateo, CA (US); Zhenzhen WANG, San Mateo, CA (US); Yen-Kuang CHEN, San Mateo, CA (US)

(21) Appl. No.: 17/010,192

(22) Filed: Sep. 2, 2020

(51) Int. Cl. G06N 3/08; G06T 3/40; G06K 9/62; G06T 1/00

(52) U.S. Cl. CPC G06N 3/08; G06T 3/4046; G06K 9/6228; G06T 1/0007; G06K 9/6256

(57) ABSTRACT

The present disclosure relates to a system and method for machine learning from partial compressed representation. In some embodiments, an exemplary machine learning system includes: a compressor having circuitry configured to use a compression neural network to compress an image into a compressed representation, the compressed representation comprising a sequence of compressed channels; a selector having circuitry configured to select a part of the compressed channels from the compressed representation; and a learning module having circuitry configured to perform a learning task on the selected compressed channels.

### BACKGROUND

Machine learning (ML) or deep learning (DL) has been growing exponentially in the last decade. ML and DL use neural networks (NN), which are mechanisms that basically mimic how a human brain learns. Neural networks (e.g., convolutional neural network (CNN))-based image compression and reconstruction are growing rapidly and can achieve or surpasses the state-of-the-art heuristic image compression methods, such as JPEG or BPG. A limitation of the application of the NN-based image compression is on the computation complexity during compression and reconstruction.

### SUMMARY

In some embodiments, an exemplary machine learning system includes: a compressor having circuitry configured to use a compression neural network to compress an image into a compressed representation, the compressed representation comprising a sequence of compressed channels; a selector having circuitry configured to select a part of the compressed channels from the compressed representation; and a learning module having circuitry configured to perform a learning task on the selected compressed channels.

In some embodiments, an exemplary method for machine learning includes: compressing an image with a compression neural network to generate a compressed representation comprising a sequence of compressed channels; selecting a part of the compressed channels from the compressed representation; and performing a learning task on the selected compressed channels.

In some embodiments, an exemplary apparatus for neural network learning includes at least one memory for storing instructions and at least one processor. At least one processor can be configured to execute the instructions to cause the apparatus to perform: compressing an image with a neural network to generate a compressed representation comprising a plurality of compressed channels; selecting a part of the compressed channels from the compressed representation; and performing a learning task on the selected compressed channels.

In some embodiments, an exemplary non-transitory computer readable storage medium storing a set of instructions that are executable by one or more processing devices to cause a computer to perform: compressing an image with a compression neural network to generate a compressed representation comprising a sequence of compressed channels; selecting a part of the compressed channels from the compressed representation; and performing a learning task on the selected compressed channels.

Additional features and advantages of the present disclosure will be set forth in part in the following detailed description, and in part will be obvious from the description, or may be learned by practice of the present disclosure. The features and advantages of the present disclosure will be realized and attained by means of the elements and combinations particularly pointed out in the appended claims.

It is to be understood that the foregoing general description and the following detailed description are exemplary and explanatory only, and are not restrictive of the disclosed embodiments.

### BRIEF DESCRIPTION OF THE DRAWINGS

The accompanying drawings, which comprise a part of this specification, illustrate several embodiments and, together with the description, serve to explain the principles and features of the disclosed embodiments. In the drawings:

FIG. 1 is a schematic representation of a neural network, according to some embodiments of the present disclosure.

FIG. 2A illustrates an exemplary neural network accelerator architecture, according to some embodiments of the present disclosure.

FIG. 2B illustrates an exemplary neural network accelerator core architecture, according to some embodiments of the present disclosure.

FIG. 2C illustrates a schematic diagram of an exemplary cloud system incorporating a neural network accelerator, according to some embodiments of the present disclosure.

FIG. 3 illustrates an exemplary operation unit configuration, according to some embodiments of the present disclosure.

FIG. 4 is a schematic representation of an exemplary machine learning process, according to some embodiments of the present disclosure.

FIG. 5 is a schematic diagram of an exemplary entropy distribution over a number of compressed channels, according to some embodiments of the present disclosure.

FIG. 6 is a schematic representation of an exemplary machine learning system, according to some embodiments of the present disclosure.

FIG. 7 is a schematic representation of another exemplary machine learning system, according to some embodiments of the present disclosure.

FIG. 8 is a schematic representation of another exemplary machine learning system, according to some embodiments of the present disclosure.

FIG. 9 is a flowchart of an exemplary method for machine learning from partial compressed representation, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses, systems and methods consistent with aspects related to the invention as recited in the appended claims.

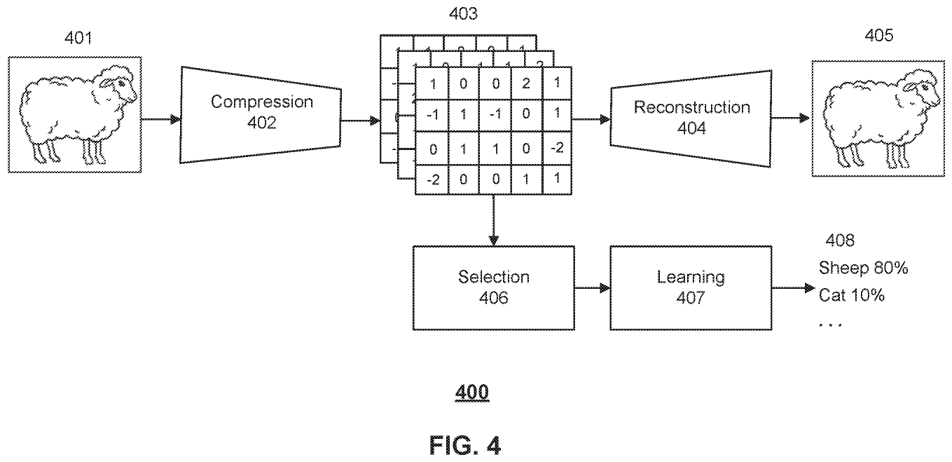

The applications of neural networks (e.g., CNNs) are extended to non-visual understanding tasks, in particular, to image compression tasks. For example, a CNN can transform an image from color space domain (e.g., RGB domain) to a compressed representation. A purpose of image compression is to remove intrinsic redundancy in the image and thus be able to use much smaller number of bits to represent it, which is beneficial both in transmission and in data storage. To perform computer vision tasks from the compressed domain, the compressed representation (e.g., compressed representation 403 including a sequence of compressed channels in FIG. 4) is reconstructed to RGB images first and then normalized to a matched size to be fed into CNNs for computer vision (CV) tasks (e.g., image classification, object detection, semantic segmentation, or the like). However, both of the CNN-based compression and reconstruction networks are computationally intensive because they are performed over original images of high resolutions. For example, a state-of-the-art four-layer CNN-based reconstruction network requires over 900 GFLOPS (Giga Floating-point Operations Per Second) to reconstruct a 1080p (1920×1080 pixels) image.

In some embodiments of the present disclosure, a system or a method can perform machine learning (e.g., training or inference) from partial compressed representations in the compressed domain without reconstruction. Some embodiments can reduce computation complexity and latency of an image learning system.

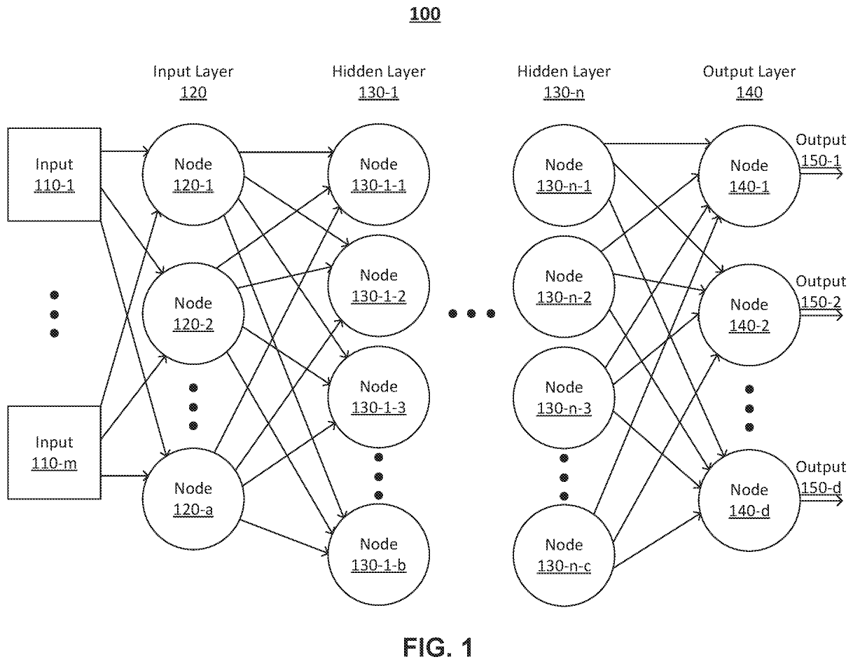

FIG. 1 is a schematic representation of a neural network (NN) 100. As depicted in FIG. 1, neural network 100 may include an input layer 120 that accepts inputs, e.g., input 110-1, . . . , input 110-m. Inputs may include an image, text, or any other structure or unstructured data for processing by neural network 100. In some embodiments, neural network 100 may accept a plurality of inputs simultaneously. For example, in FIG. 1, neural network 100 may accept up to m inputs simultaneously. Additionally or alternatively, input layer 120 may accept up to m inputs in rapid succession, e.g., such that input 110-1 is accepted by input layer 120 in one cycle, a second input is accepted by input layer 120 in a second cycle in which input layer 120 pushes data from input 110-1 to a first hidden layer, and so on. Any number of inputs can be used in simultaneous input, rapid succession input, or the like.

Input layer 120 may comprise one or more nodes, e.g., node 120-1, node 120-2, . . . , node 120-a. Each node may apply an activation function to corresponding input (e.g., one or more of input 110-1, . . . , input 110-m) and weight the output from the activation function by a particular weight associated with the node. An activation function may comprise a Heaviside step function, a Gaussian function, a multiquadratic function, an inverse multi-quadratic function, a sigmoidal function, or the like. A weight may comprise a positive value between 0.0 and 1.0 or any other numerical value configured to allow some nodes in a layer to have corresponding output scaled more or less than output corresponding to other nodes in the layer.

As further depicted in FIG. 1, neural network 100 may include one or more hidden layers, e.g., hidden layer 130-1, . . . , hidden layer 130-n. Each hidden layer may comprise one or more nodes. For example, in FIG. 1, hidden layer 130-1 comprises node 130-1-1, node 130-1-2, node 130-1-3, . . . , node 130-1-b, and hidden layer 130-n comprises node 130-n-1, node 130-n-2, node 130-n-3, . . . , node 130-n-c. Similar to nodes of input layer 120, nodes of the hidden layers may apply activation functions to output from connected nodes of the previous layer and weight the output from the activation functions by particular weights associated with the nodes.

As further depicted in FIG. 1, neural network 100 may include an output layer 140 that finalizes outputs, e.g., output 150-1, output 150-2, . . . , output 150-d. Output layer 140 may comprise one or more nodes, e.g., node 140-1, node 140-2, . . . , node 140-d. Similar to nodes of input layer 120 and of the hidden layers, nodes of output layer 140 may apply activation functions to output from connected nodes of the previous layer and weight the output from the activation functions by particular weights associated with the nodes.

Although depicted as fully connected in FIG. 1, the layers of neural network 100 may use any connection scheme. For example, one or more layers (e.g., input layer 120, hidden layer 130-1, . . . , hidden layer 130-n, output layer 140, or the like) may be connected using a convolutional scheme, a sparsely connected scheme, or the like. Such embodiments may use fewer connections between one layer and a previous layer than depicted in FIG. 1.

Moreover, although depicted as a feedforward network in FIG. 1, neural network 100 may additionally or alternatively use backpropagation (e.g., by using long short-term memory nodes or the like). Accordingly, although neural network 100 is depicted similar to a CNN, neural network 100 may comprise a recurrent neural network (RNN) or any other neural network.

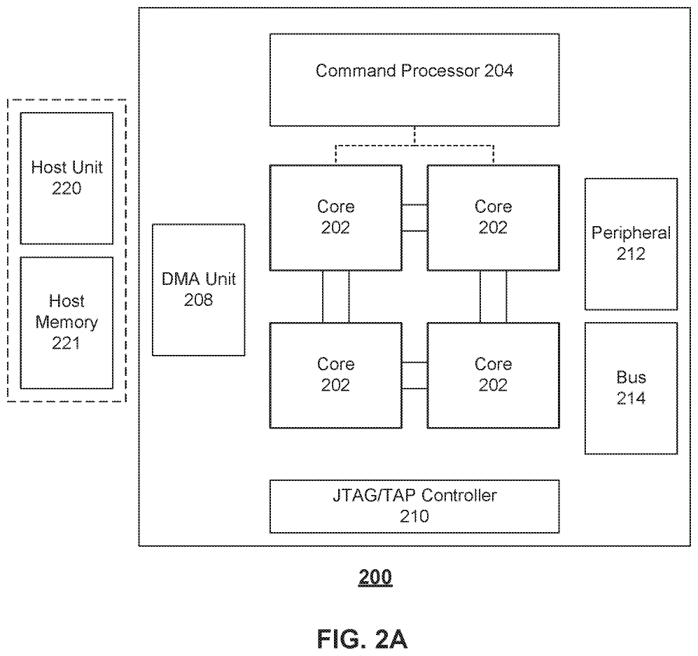

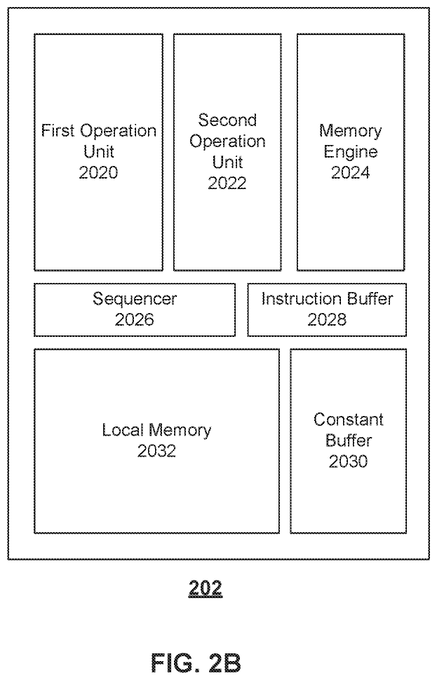

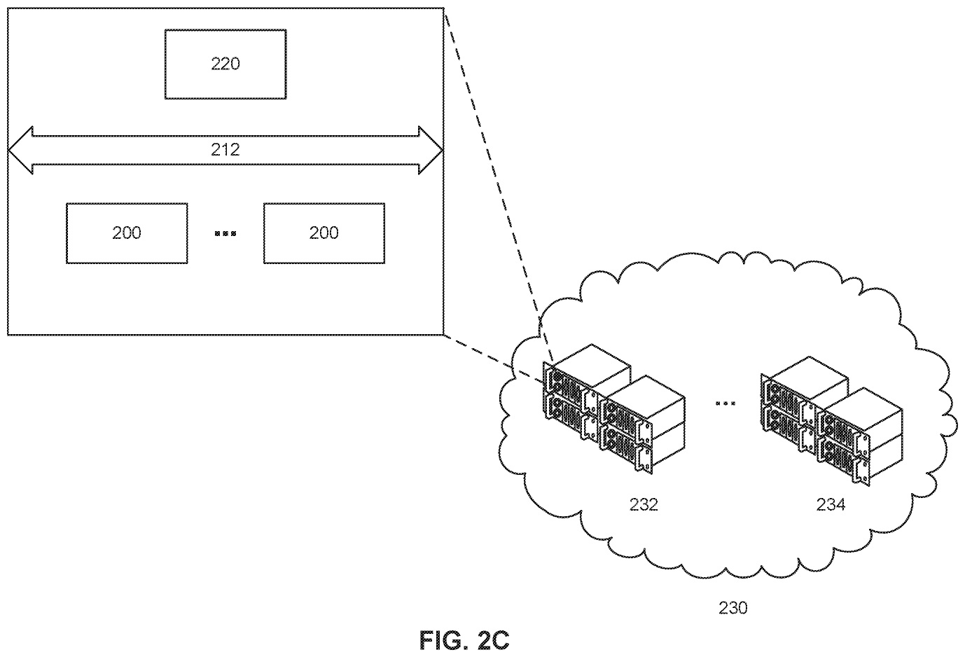

FIG. 2A illustrates an exemplary neural network accelerator architecture 200, according to some embodiments of the present disclosure. In the context of this disclosure, a neural network accelerator may also be referred to as a machine learning accelerator or deep learning accelerator. In some embodiments, accelerator architecture 200 may be referred to as a neural network processing unit (NPU) architecture 200. As shown in FIG. 2A, accelerator architecture 200 can include a plurality of cores 202, a command processor 204, a direct memory access (DMA) unit 208, a Joint Test Action Group (JTAG)/Test Access Port (TAP) controller 210, a peripheral interface 212, a bus 214, and the like.

It is appreciated that cores 202 can perform algorithmic operations based on communicated data. Cores 202 can include one or more processing elements that may include single instruction, multiple data (SIMD) architecture including one or more processing units configured to perform one or more operations (e.g., multiplication, addition, multiply-accumulate, etc.) based on commands received from command processor 204. To perform the operation on the communicated data packets, cores 202 can include one or more processing elements for processing information in the data packets. Each processing element may comprise any number of processing units. According to some embodiments of the present disclosure, accelerator architecture 200 may include a plurality of cores 202, e.g., four cores. In some embodiments, the plurality of cores 202 can be communicatively coupled with each other. For example, the plurality of cores 202 can be connected with a single directional ring bus, which supports efficient pipelining for large neural network models. The architecture of cores 202 will be explained in detail with respect to FIG. 2B.

Command processor 204 can interact with a host unit 220 and pass pertinent commands and data to corresponding core 202. In some embodiments, command processor 204 can interact with host unit under the supervision of kernel mode driver (KMD). In some embodiments, command processor 204 can modify the pertinent commands to each core 202, so that cores 202 can work in parallel as much as possible. The modified commands can be stored in an instruction buffer (not shown). In some embodiments, command processor 204 can be configured to coordinate one or more cores 202 for parallel execution.

DMA unit 208 can assist with transferring data between host memory 221 and accelerator architecture 200. For example, DMA unit 208 can assist with loading data or instructions from host memory 221 into local memory of cores 202. DMA unit 208 can also assist with transferring data between multiple accelerators. DMA unit 208 can allow off-chip devices to access both on-chip and off-chip memory without causing a host CPU interrupt. In addition, DMA unit 208 can assist with transferring data between components of accelerator architecture 200. For example, DMA unit 208 can assist with transferring data between multiple cores 202 or within each core. Thus, DMA unit 208 can also generate memory addresses and initiate memory read or write cycles. DMA unit 208 also can contain several hardware registers that can be written and read by the one or more processors, including a memory address register, a byte-count register, one or more control registers, and other types of registers. These registers can specify some combination of the source, the destination, the direction of the transfer (reading from the input/output (I/O) device or writing to the I/O device), the size of the transfer unit, or the number of bytes to transfer in one burst. It is appreciated that accelerator architecture 200 can include a second DMA unit, which can be used to transfer data between other accelerator architectures to allow multiple accelerator architectures to communicate directly without involving the host CPU.

JTAG/TAP controller 210 can specify a dedicated debug port implementing a serial communications interface (e.g., a JTAG interface) for low-overhead access to the accelerator without requiring direct external access to the system address and data buses. JTAG/TAP controller 210 can also have on-chip test access interface (e.g., a TAP interface) that implements a protocol to access a set of test registers that present chip logic levels and device capabilities of various parts.

Peripheral interface 212 (such as a PCIe interface), if present, serves as an (and typically the) inter-chip bus, providing communication between the accelerator and other devices.

Bus 214 (such as a I2C bus) includes both intra-chip bus and inter-chip buses. The intra-chip bus connects all internal components to one another as called for by the system architecture. While not all components are connected to every other component, all components do have some connection to other components they need to communicate with. The inter-chip bus connects the accelerator with other devices, such as the off-chip memory or peripherals. For example, bus 214 can provide high speed communication across cores and can also connect cores 202 with other units, such as the off-chip memory or peripherals. Typically, if there is a peripheral interface 212 (e.g., the inter-chip bus), bus 214 is solely concerned with intra-chip buses, though in some implementations it could still be concerned with specialized inter-bus communications.

Accelerator architecture 200 can also communicate with a host unit 220. Host unit 220 can be one or more processing unit (e.g., an X86 central processing unit). As shown in FIG. 2A, host unit 220 may be associated with host memory 221. In some embodiments, host memory 221 may be an integral memory or an external memory associated with host unit 220. In some embodiments, host memory 221 may comprise a host disk, which is an external memory configured to provide additional memory for host unit 220. Host memory 221 can be a double data rate synchronous dynamic random-access memory (e.g., DDR SDRAM) or the like. Host memory 221 can be configured to store a large amount of data with slower access speed, compared to the on-chip memory integrated within accelerator chip, acting as a higher-level cache. The data stored in host memory 221 may be transferred to accelerator architecture 200 to be used for executing neural network models.

In some embodiments, a host system having host unit 220 and host memory 221 can comprise a compiler (not shown). The compiler is a program or computer software that transforms computer codes written in one programming language into instructions for accelerator architecture 200 to create an executable program. In machine learning applications, a compiler can perform a variety of operations, for example, pre-processing, lexical analysis, parsing, semantic analysis, conversion of input programs to an intermediate representation, initialization of a neural network, code optimization, and code generation, or combinations thereof. For example, the compiler can compile a neural network to generate static parameters, e.g., connections among neurons and weights of the neurons.

In some embodiments, host system including the compiler may push one or more commands to accelerator architecture 200. As discussed above, these commands can be further processed by command processor 204 of accelerator architecture 200, temporarily stored in an instruction buffer of accelerator architecture 200, and distributed to corresponding one or more cores (e.g., cores 202 in FIG. 2A) or processing elements. Some of the commands may instruct a DMA unit (e.g., DMA unit 208 of FIG. 2A) to load instructions and data from host memory (e.g., host memory 221 of FIG. 2A) into accelerator architecture 200. The loaded instructions may then be distributed to each core (e.g., core 202 of FIG. 2A) assigned with the corresponding task, and the one or more cores may process these instructions.

It is appreciated that the first few instructions received by the cores 202 may instruct the cores 202 to load/store data from host memory 221 into one or more local memories of the cores (e.g., local memory 2032 of FIG. 2B). Each core 202 may then initiate the instruction pipeline, which involves fetching the instruction (e.g., via a sequencer) from the instruction buffer, decoding the instruction (e.g., via a DMA unit 208 of FIG. 2A), generating local memory addresses (e.g., corresponding to an operand), reading the source data, executing or loading/storing operations, and then writing back results.

According to some embodiments, accelerator architecture 200 can further include a global memory (not shown) having memory blocks (e.g., 4 blocks of 8 GB second generation of high bandwidth memory (HBM2)) to serve as main memory. In some embodiments, the global memory can store instructions and data from host memory 221 via DMA unit 208. The instructions can then be distributed to an instruction buffer of each core assigned with the corresponding task, and the core can process these instructions accordingly.

In some embodiments, accelerator architecture 200 can further include memory controller (not shown) configured to manage reading and writing of data to and from a specific memory block (e.g., HBM2) within global memory. For example, memory controller can manage read/write data coming from core of another accelerator (e.g., from DMA unit 208 or a DMA unit corresponding to the another accelerator) or from core 202 (e.g., from a local memory in core 202). It is appreciated that more than one memory controller can be provided in accelerator architecture 200. For example, there can be one memory controller for each memory block (e.g., HBM2) within global memory.

Memory controller can generate memory addresses and initiate memory read or write cycles. Memory controller can contain several hardware registers that can be written and read by the one or more processors. The registers can include a memory address register, a byte-count register, one or more control registers, and other types of registers. These registers can specify some combination of the source, the destination, the direction of the transfer (reading from the input/output (I/O) device or writing to the I/O device), the size of the transfer unit, the number of bytes to transfer in one burst, or other typical features of memory controllers.

While accelerator architecture 200 of FIG. 2A can be used for convolutional neural networks (CNNs) in some embodiments of the present disclosure, it is appreciated that accelerator architecture 200 of FIG. 2A can be utilized in various neural networks, such as deep neural networks (DNNs), recurrent neural networks (RNNs), or the like. In addition, some embodiments can be configured for various processing architectures, such as neural network processing units (NPUs), graphics processing units (GPUs), tensor processing units (TPUs), any other types of accelerators, or the like.

FIG. 2B illustrates an exemplary neural network accelerator core architecture, according to some embodiments of the present disclosure. As shown in FIG. 2B, core 202 can include one or more operation units such as first and second operation units 2020 and 2022, a memory engine 2024, a sequencer 2026, an instruction buffer 2028, a constant buffer 2030, a local memory 2032, or the like.

One or more operation units can include first operation unit 2020 and second operation unit 2022. First operation unit 2020 can be configured to perform operations on received data (e.g., matrices). In some embodiments, first operation unit 2020 can include one or more processing units configured to perform one or more operations (e.g., multiplication, addition, multiply-accumulate, element-wise operation, etc.). In some embodiments, first operation unit 2020 is configured to accelerate execution of convolution operations or matrix multiplication operations.

Second operation unit 2022 can be configured to perform a pooling operation, an interpolation operation, a region-of-interest (ROI) operation, and the like. In some embodiments, second operation unit 2022 can include an interpolation unit, a pooling data path, and the like.

Memory engine 2024 can be configured to perform a data copy within a corresponding core 202 or between two cores. DMA unit 208 can assist with copying data within a corresponding core or between two cores. For example, DMA unit 208 can support memory engine 2024 to perform data copy from a local memory (e.g., local memory 2032 of FIG. 2B) into a corresponding operation unit. Memory engine 2024 can also be configured to perform matrix transposition to make the matrix suitable to be used in the operation unit.

Sequencer 2026 can be coupled with instruction buffer 2028 and configured to retrieve commands and distribute the commands to components of core 202. For example, sequencer 2026 can distribute convolution commands or multiplication commands to first operation unit 2020, distribute pooling commands to second operation unit 2022, or distribute data copy commands to memory engine 2024. Sequencer 2026 can also be configured to monitor execution of a neural network task and parallelize sub-tasks of the neural network task to improve efficiency of the execution. In some embodiments, first operation unit 2020, second operation unit 2022, and memory engine 2024 can run in parallel under control of sequencer 2026 according to instructions stored in instruction buffer 2028.

Instruction buffer 2028 can be configured to store instructions belonging to the corresponding core 202. In some embodiments, instruction buffer 2028 is coupled with sequencer 2026 and provides instructions to the sequencer 2026. In some embodiments, instructions stored in instruction buffer 2028 can be transferred or modified by command processor 204.

Constant buffer 2030 can be configured to store constant values. In some embodiments, constant values stored in constant buffer 2030 can be used by operation units such as first operation unit 2020 or second operation unit 2022 for batch normalization, quantization, de-quantization, or the like.

Local memory 2032 can provide storage space with fast read/write speed. To reduce possible interaction with a global memory, storage space of local memory 2032 can be implemented with large capacity. With the massive storage space, most of data access can be performed within core 202 with reduced latency caused by data access. In some embodiments, to minimize data loading latency and energy consumption, static random access memory (SRAM) integrated on chip can be used as local memory 2032. In some embodiments, local memory 2032 can have a capacity of 192 MB or above. According to some embodiments of the present disclosure, local memory 2032 be evenly distributed on chip to relieve dense wiring and heating issues.

FIG. 2C illustrates a schematic diagram of an exemplary cloud system incorporating a neural network accelerator 200, according to some embodiments of the present disclosure. As shown in FIG. 2C, cloud system 230 can provide a cloud service with artificial intelligence (AI) capabilities and can include a plurality of computing servers (e.g., 232 and 234). In some embodiments, a computing server 232 can, for example, incorporate a neural network accelerator architecture 200 of FIG. 2A. Neural network accelerator architecture 200 is shown in FIG. 2C in a simplified manner for simplicity and clarity.

With the assistance of neural network accelerator architecture 200, cloud system 230 can provide the extended AI capabilities of image recognition, facial recognition, translations, 3D modeling, and the like. It is appreciated that neural network accelerator architecture 200 can be deployed to computing devices in other forms. For example, neural network accelerator architecture 200 can also be integrated in a computing device, such as a smart phone, a tablet, and a wearable device.

Moreover, while a neural network accelerator architecture is shown in FIGS. 2A-2B, it is appreciated that any accelerator that provides the ability to perform parallel computation can be used.

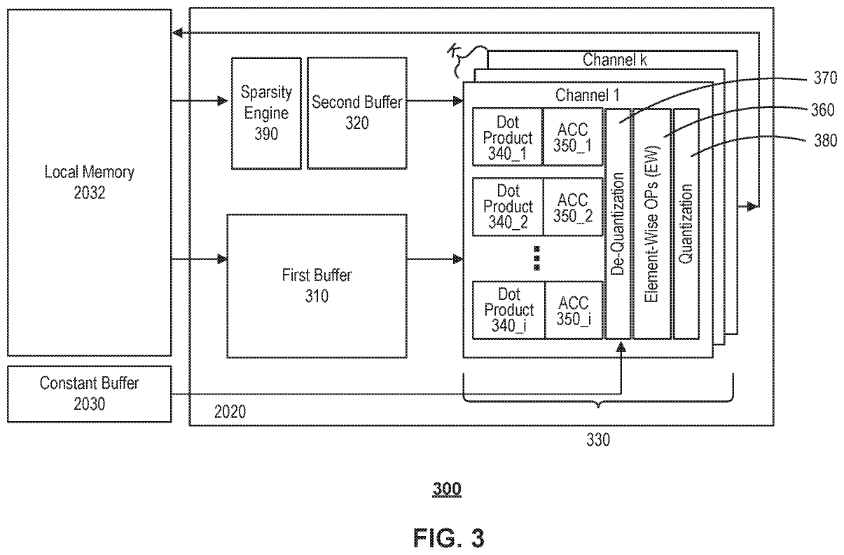

FIG. 3 illustrates an exemplary operation unit configuration 300, according to some embodiments of the present disclosure. According to some embodiments of the present disclosure, operation unit can be first operation unit (e.g., first operation unit 2020 in FIG. 2B). Operation unit 2020 may include a first buffer 310, a second buffer 320, and a processing array 330.

First buffer 310 may be configured to store input data. In some embodiments, data stored in first buffer 310 can be input data to be used in processing array 330 for execution. In some embodiments, the input data can be fetched from local memory (e.g., local memory 2032 in FIG. 2B). First buffer 310 may be configured to support reuse or share of data to be used in processing array 330. In some embodiments, input data stored in first buffer 310 may be activation data for a convolution operation.

Second buffer 320 may be configured to store weight data. In some embodiments, weight data stored in second buffer 320 can be used in processing array 330 for execution. In some embodiments, the weight data stored in second buffer 320 can be fetched from local memory (e.g., local memory 2032 in FIG. 1B). In some embodiments, weight data stored in second buffer 320 may be filter data for a convolution operation.

According to some embodiments of the present disclosure, weight data stored in second buffer 320 can be compressed data. For example, weight data can be pruned data to save memory space on chip. In some embodiments, operation unit 2020 can further include a sparsity engine 390. Sparsity engine 390 can be configured to unzip compressed weight data to be used in processing array 330.

Processing array 330 may have a plurality of layers (e.g., K layers). According to some embodiments of the present disclosure, each layer of processing array 330 may include a plurality of processing strings, which may perform computations in parallel. For example, first processing string included in the first layer of processing array 330 can comprise a first multiplier (e.g., dot product) 340_1 and a first accumulator (ACC) 350_1 and second processing string can comprise a second multiplier 340_2 and a second accumulator 350_2. Similarly, i-th processing string in the first layer can comprise an i-th multiplier 340_i and an i-th accumulator 350_i.

In some embodiments, processing array 330 can perform computations under SIMD control. For example, when performing a convolution operation, each layer of processing array 330 can execute same instructions with different data.

According to some embodiments of the present disclosure, processing array 330 shown in FIG. 3 can be included in a core (e.g., core 202 in FIG. 2B). When a number of processing strings (e.g., i number of processing strings) included in one layer of processing array 330 is smaller than a number of work items (e.g., B number of work items), i number of work items can be executed by processing array 330 and subsequently the rest of work items (B-i number of work items) can be executed by the processing array 330 in some embodiments. In some other embodiments, i number of work items can be executed by processing array 330 and the rest of work items can be executed by another processing array 330 in another core.

According to some embodiments of the present disclosure, processing array 330 may further include an element-wise operation processor (OP) 360. In some embodiments, element-wise operation processor 360 can be positioned at the end of processing strings. In some embodiments, processing strings in each layer of processing array 330 can share element-wise operation processor 360. For example, i number of processing strings in the first layer of processing array 330 can share element-wise operation processor 360. In some embodiments, element-wise operation processor 360 in the first layer of processing array 330 can perform its element-wise operation on each of output values, from accumulators 350_1 to 350_i, sequentially. Similarly, element-wise operation processor 360 in the Kth layer of processing array 330 can perform its element-wise operation on each of output values, from accumulators 350_1 to 350_i, sequentially. In some embodiments, element-wise operation processor 360 can be configured to perform a plurality of element-wise operations. In some embodiments, element-wise operation performed by the element-wise operation processor 360 may include an activation function such as ReLU function, ReLU6 function, Leaky ReLU function, Sigmoid function, Tanh function, or the like.

In some embodiments, multiplier 340 or accumulator 350 may be configured to perform its operation on different data type from what the element-wise operation processor 360 performs its operations on. For example, multiplier 340 or accumulator 350 can be configured to perform its operations on integer type data such as Int 8, Int 16, and the like and element-wise operation processor 360 can perform its operations on floating point type data such as FP24, and the like. Therefore, according to some embodiments of the present disclosure, processing array 330 may further include de-quantizer 370 and quantizer 380 with element-wise operation processor 360 positioned therebetween. In some embodiments, batch normalization operations can be merged to de-quantizer 370 because both de-quantizer 370 and batch normalization operations can be performed by multiplication operations and addition operations with constants, which can be provided from constant buffer 2030. In some embodiments, batch normalization operations and de-quantization operations can be merged into one operation by compiler. As shown in FIG. 3, constant buffer 2030 can provide constants to de-quantizer 370 for de-quantization or batch normalization.

FIG. 4 is a schematic representation of an exemplary machine learning process 400, according to some embodiments of the present disclosure. It is appreciated that learning process 400 can be implemented by neural network accelerator architecture 200 of FIG. 2A. Moreover, process 400 can also be implemented by a computer program product, embodied in a computer-readable medium, including computer-executable instructions, such as program code, executed by computers, such as the systems or architectures as shown in FIG. 2A, FIG. 2B, FIG. 2C, and FIG. 3. In some embodiments, a host unit (e.g., host unit 220 of FIG. 2A) may compile software code for generating instructions for providing to one or more neural network accelerators (e.g., neural network accelerator 200 of FIG. 2A) to perform process 400.

As shown in FIG. 4, an image 401 (e.g., a photo of a sheep) can be input into compression stage 402 that can include a compression neural network (NN) (e.g., neural network 100 of FIG. 1). In some embodiments, the compression neural network can be a CNN, a RNN, or the like. At compression stage 402, the compression neural network can perform a NN-based compression on image 401, and generate a compressed representation 403. Compressed representation 403 can include a sequence of compressed channels (or features, feature maps), as shown in FIG. 4, each of which can include a plurality of signals (e.g., a matrix of signals). For example, a CNN can utilize a plurality of filters (or kernel) to compress an RGB image 401 and generate a plurality of compressed channels each of which can include a matrix of signals.

Compressed representation 403 can be input into reconstruction stage 404. Stage 404 can include a reconstruction neural network (e.g., neural network 100 of FIG. 1). In some embodiments, the reconstruction neural network can be a CNN, a RNN, or the like. At stage 404, the reconstruction neural network can perform a NN-based reconstruction on compressed representation 403, and generate a reconstructed image 405. For example, a four-layer reconstruction CNN can transform the sequence of compressed channels in compressed representation 403 to a reconstructed RGB image 405. It is appreciated that, reconstructed image 405 can be the same as or different from image 401. For example, reconstructed image 405 can be of lower resolution or size than that of image 401.

In some embodiments, compressed representation 403 can be input into selection stage 406. At selection stage 406, a part of the sequence of compressed channels in compressed representation 403 can be selected. The selection can be based on statistics (e.g., entropies or feature value variations) of the compressed channels, a trained selection neural network, or the like. In some embodiments, at selection stage 406, a plurality of top compressed channels with larger entropies or feature value variances can be selected. For example, regarding a channel including n signals, s₀, s₁, . . . , sᵢ, . . . , sₙ₋₁, the entropy H of the channel can be calculated as follows,

H=−Σᵢ₌₀ⁿ⁻¹(pᵢ×log₂pᵢ) (Eq. 1)

where pᵢ represents a probability of a signal being equal to sᵢ. Moreover, the feature value variance S of the channel can be calculated as follows,

$$S = \frac{{\sum }_{i = 0}^{n - 1} {( {s}_{i} - \overline{s} )}^{2}}{n} \qquad ( Eq . 2 )$$

where s̅ represents a mean value of the n signals.

In some embodiments, the compressed channels can be sorted by entropy or feature value variance of signals therein. The top C compressed channels with largest entropies or feature value variances can be selected. The number C can be determined based on the entropy distribution or feature value variance distribution over the compressed channels.

In some embodiments, the sequence of compressed channels can be input into a selection neural network that can select a plurality of compressed channels. The selection neural network can be trained to perform the selection and achieve good performance during learning with the selection.

The selected channels of compressed representation 403 can be input to learning stage 407 where a learning task can be performed thereon. It is appreciated that, learning task in the present disclosure can include both training or inference of a learning neural network and can be applied to various CV tasks, including, but not being limited to, image recognition, image classification, object detection, semantic segmentation, or the like. In some embodiments, process 400 can also include a resizing stage at which the selected compressed channels can be adjusted to the input size of the learning neural network. The resizing stage can include a DNN layer to perform the adjustment.

As shown in FIG. 4, for example, at learning stage 407, the learning neural network can perform an image recognition. Specifically, the learning neural network (e.g., neural network 100 of FIG. 1) can receive selected channels of compressed representation 403 from selection stage 406, and perform a forward propagation (FP) from an input layer (e.g., input layer 120 of FIG. 1), through one or more hidden layers (e.g., hidden layers 130-1, . . . , 130-n of FIG. 1), to an output layer (e.g., output layer 140 of FIG. 1). Then the learning neural network can provide an output 408, e.g., an evaluation result. As depicted in FIG. 4, the output 408 can include a plurality of possible evaluation items with respective probabilities (e.g., “sheep 80%”, “cat 10%”, or the like). The item with the highest probability can be determined as final recognition result (e.g., a sheep).

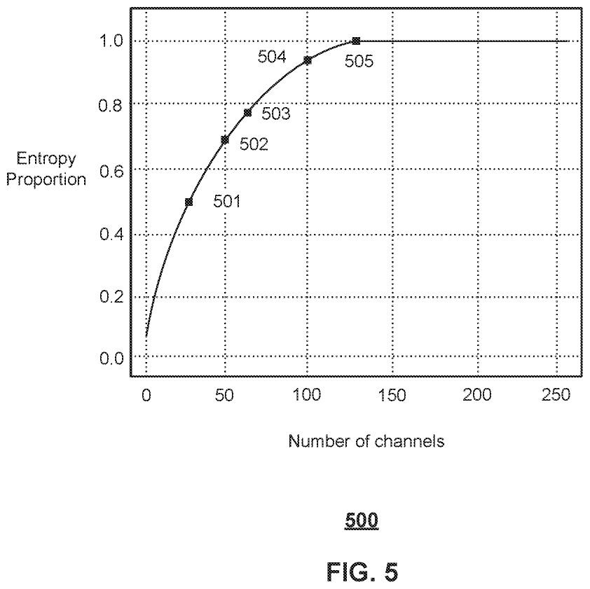

FIG. 5 is a schematic diagram of an exemplary entropy distribution 500 over a number of compressed channels, according to some embodiments of the present disclosure. A four-layer CNN can be utilized to compress an image with a plurality of filters and generate a compressed representation having 256 channels. For each channel, an entropy can be calculated using signals based on Eq. 1. The compressed channels can be sorted from the largest calculated entropy to lowest calculated entropy. FIG. 5 illustrates the entropy portion of the top channels over the number of the top channels. As shown in FIG. 5, at point 501, for top 32 channels with largest entropies, the sum of entropies occupies 49.7% of total sum of entropies of all channels. From point 502 with 50 channels to point 503 with 64 channels, and to point 504 with 100 channels, the entropy portion changes from 63.7% to 76.6%, and to 87%, respectively. At points 505, for top 128 channels with largest entropies, the sum of entropies occupies close to 100% of total sum of entropies of all channels. The contribution of bottom 128 channels with small entropies to total sum of entropies is close to zero. Thus, top channels can be selected to perform learning task to reduce computations or transmission bandwidth. For example, a learning neural network can be trained for image classification with all compressed channels and achieve an accuracy of 73.42%, while the learning neural network can be trained with 32 compressed channels out of 256 channels (49.7% entropy proportion, as shown at point 501 of FIG. 5) and achieve an accuracy of 73.44%.

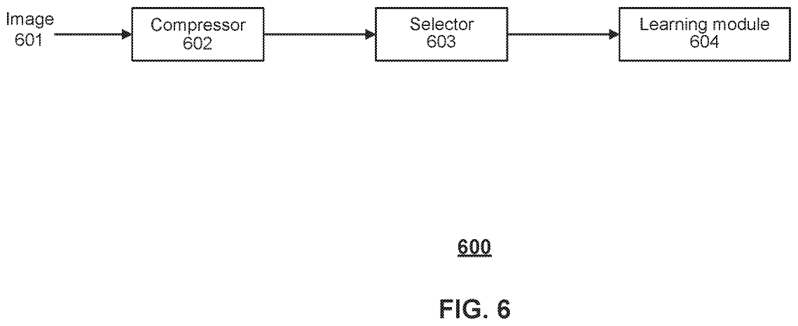

FIG. 6 is a schematic representation of an exemplary machine learning system 600, according to some embodiments of the present disclosure. It is appreciated that, machine learning system 600 can be implemented, at least partially, by neural network accelerator 200 of FIGS. 2A and 2C, core 202 of FIGS. 2A-2B, or cloud system 230 of FIG. 2C, and can perform at least part of learning process 400 of FIG. 4.

As depicted in FIG. 6, machine learning system 600 can include a compressor 602, a selector 603, a learning module 604, and the like. Compressor 602 can receive an input, e.g., an image, and have circuitry configured to compress it to a compressed representation having a plurality of compressed channels (e.g., compressed representation 403 of FIG. 4). For example, compressor 602 can have circuitry configured to execute a compression neural network (e.g., a trained compression CNN, RNN, or the like) to compress the input RGB image to a plurality of compressed channels.

Selector 603 can be coupled with compressor 602, as shown in FIG. 6. Selector 603 can receive the compressed representation and have circuitry configured to select a part of compressed channels of the compressed representation. In some embodiments, selector 603 can have circuitry configured to select a number C of top compressed channels with largest entropies or feature value variances from the compressed representation. The number C can be a positive integer and determined based on the entropy distribution or feature value variance distribution over the compressed channels. In some embodiments, selector 603 can have circuitry configured to execute a selection neural network. The selection neural network can be trained to select a plurality of compressed channels from the compressed representation.

Learning module 604 can be coupled with selector 603, as shown in FIG. 6. Learning module 604 can have circuitry configured to perform a machine learning on the selected compressed channels from selector 603. In some embodiments, learning module 604 can have circuitry configured to execute a learning neural network (e.g., neural network 100 of FIG. 1), e.g., a CNN, a RNN, or the like. The learning neural network can have circuitry configured to perform a training or inference with the selected compressed channels. For example, the learning neural network can be pre-trained to perform a CV task, e.g., image recognition (e.g., process 400 of FIG. 4), image classification, object detection, semantic segmentation, or the like.

In some embodiments, machine learning system 600 can also include a resizing module. The resizing module can have circuitry configured to adjust the selected compressed channels to the input size of the learning module. For example, the resizing module can have circuitry configured to execute a DNN layer to perform the adjustment.

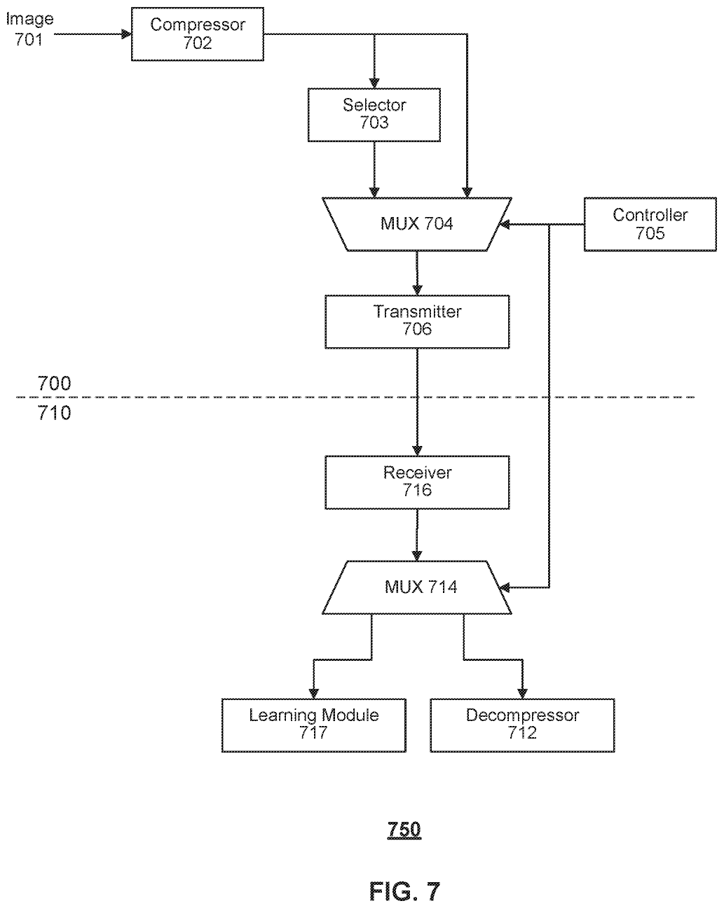

FIG. 7 illustrates a schematic representation of an exemplary machine learning system 750, according to some embodiments of the present disclosure. It is appreciated that, machine learning system 750 can be implemented, at least partially, by neural network accelerator 200 of FIGS. 2A and 2C, core 202 of FIGS. 2A-2B, or cloud system 230 of FIG. 2C, and can perform at least part of learning process 400 of FIG. 4.

As depicted in FIG. 7, machine learning system 750 can include a compression apparatus 700 and a learning apparatus 710. It is appreciated that, although shown as separate apparatuses, a compression apparatus 700 and a learning apparatus 710 can be integrated together. Compression apparatus 700 can include a compressor 702, a selector 703, a multiplexer (MUX) 704, a controller 705, a transmitter 706, and the like.

Compressor 702 can receive an input 701, e.g., an image, and have circuitry configured to compress it to a compressed representation having a plurality of compressed channels. Compressor 702 can have circuitry configured to execute a compression neural network (e.g., a trained compression CNN, RNN, or the like) that can compress the input RGB image 701 to a plurality of compressed channels.

Selector 703 can receive the compressed representation and have circuitry configured to select a part of compressed channels of the compressed representation. In some embodiments, selector 703 can select C top compressed channels with largest entropies or feature value variances from the compressed representation. The number C can be determined based on the entropy distribution or feature value variance distribution over the compressed channels. In some embodiments, selector 703 can have circuitry configured to execute a selection neural network that can be trained to select a plurality of compressed channels from the compressed representation.

Multiplexer 704 can be coupled with compressor 702 and selector 703. Then, multiplexer 704 can receive the compressed representation from compressor 702 and the selected compressed channels from selector 703 and have circuitry configured to multiplex these input data. Multiplexer 704 can be coupled to transmitter 706 and output the compressed representation or the selected compressed channels to transmitter 706.

Controller 705 can be coupled to multiplexer 704 to provide a control signal. The control signal can indicate how to multiplex the compressed representation from compressor 702 and selected compressed channels from selector 703. Controller 705 can have circuitry configured to generate the control signal according to an input from a user, a pre-determined definition, a user-defined standard, or the like. For example, controller 705 can have circuitry configured to determine, according to a user-defined standard, whether to use all compressed channels or partial compressed channels based on tasks, e.g., image reconstruction or image learning. In a case that image 701 is to be applied to semantic segmentation, controller 705 can determine to use partial channels and send a control signal to multiplexer 704, indicating to use the selected compressed channels from selector 703. Multiplexer 704 can output, according to the control signal, the selected compressed channels to transmitter 706.

Transmitter 706 can transmit the compressed representation or the selected compressed channels to receiver 716 of learning apparatus 710. Learning apparatus 710 can include a multiplexer (MUX) 714 that can be coupled to receiver 716 and receive therefrom the compressed representation or the selected compressed channels. It is appreciated that, in some embodiments, compression apparatus 700 can include a memory (not shown in FIG. 7), instead of transmitter 706, that can be coupled to multiplexer 704 and store the compressed representation or the selected compressed channels output from multiplexer 704. In this case, multiplexer 714 can have circuitry configured to read the compressed representation or the selected compressed channels from the memory.

Learning apparatus 710 can also include a learning module 717 and a decompressor 712 that can be coupled with multiplexer 714. Multiplexer 714 can have circuitry configured to multiplex the received (e.g., received from receiver 716 or read from the memory) compressed representation or selected compressed channels, and output it to learning module 717 or decompressor 712.

Controller 705 can be coupled to multiplexer 714 to provide a control signal. In some embodiments, learning apparatus 710 can include a controller (not shown in FIG. 7) separate from controller 705. The control signal can indicate how to multiplex the compressed representation and selected compressed channels. In some embodiments, the control signal to multiplexer 714 can be the same as that to multiplexer 704. For example, in a case that image 701 is to be applied to semantic segmentation, the control signal can indicate to use the selected compressed channels. Multiplexer 714 can output, according to the control signal, the received or read selected compressed channels to learning module 717. In a case that image is to be reconstructed, the control signal can indicate to use the compressed representation. Multiplexer 714 can output, according to the control signal, the received or read the compressed representation to decompressor 712.

Learning module 717 can have circuitry configured to perform a machine learning on the selected compressed channels. In some embodiments, learning module 717 can have circuitry configured to execute a learning neural network (e.g., neural network 100 of FIG. 1), e.g., a CNN, a RNN, or the like. The learning neural network can be pre-trained to perform a CV task, e.g., image recognition, image classification, object detection, semantic segmentation, or the like. For example, as shown in FIG. 4, the learning neural network can perform an image recognition and output a plurality of possible evaluation items with respective probabilities (e.g., “sheep 80%”, “cat 10%”, or the like).

Decompressor 712 can have circuitry configured to perform a reconstruction on the compressed representation. In some embodiments, decompressor 712 can have circuitry configured to execute a reconstruction neural network (e.g., neural network 100 of FIG. 1), e.g., a CNN, a RNN, or the like. The reconstruction neural network can perform a NN-based reconstruction on compressed representation, and generate a reconstructed image. The reconstructed image can be the same RGB image as or different image from the original image 701.

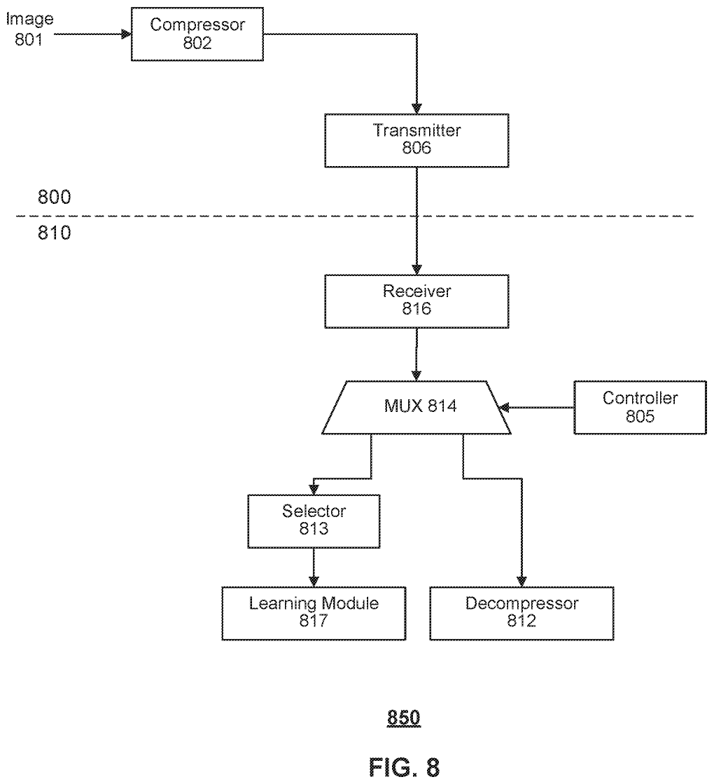

FIG. 8 is a schematic representation of another exemplary machine learning system 850, according to some embodiments of the present disclosure. It is appreciated that, machine learning system 850 can be implemented, at least partially, by neural network accelerator 200 of FIGS. 2A and 2C, core 202 of FIGS. 2A-2B, or cloud system 230 of FIG. 2C, and can perform at least part of learning process 400 of FIG. 4.

As depicted in FIG. 8, machine learning system 850 can include a compression apparatus 800 and a learning apparatus 810. It is appreciated that, although shown as separate apparatuses, a compression apparatus 800 and a learning apparatus 810 can be integrated together. Compression apparatus 800 can include a compressor 802, a transmitter 806, and the like.

Compressor 802 can receive an input 801, e.g., an image, and have circuitry configured to compress it to a compressed representation having a plurality of compressed channels (e.g., compressed representation 403 of FIG. 4). Compressor 802 can have circuitry configured to execute a compression neural network (e.g., a trained compression CNN, RNN, or the like) that can compress the input RGB image 801 to a plurality of compressed channels. Each channel can include a plurality of signals (e.g., a matrix of signals).

Transmitter 806 can be coupled to compressor 802 and transmit the compressed representation to receiver 816 of learning apparatus 810. Learning apparatus 810 can include a multiplexer (MUX) 814 that can be coupled to receiver 816 and receive therefrom the compressed representation. It is appreciated that, in some embodiments, compression apparatus 800 can include a memory (not shown in FIG. 8), instead of transmitter 806, that can be coupled to compressor 802 and store the compressed representation from compressor 802. In this case, multiplexer 814 can have circuitry configured to read the compressed representation from the memory of compression apparatus 800.

Learning apparatus 810 can also include a controller 805, a selector 813, a learning module 817, a decompressor 812, and the like. Controller 805 can be coupled to multiplexer 814 to provide a control signal. The control signal can indicate how to multiplex the compressed representation. Controller 805 can have circuitry configured to generate the control signal according to an input from a user, a pre-determined definition, a user-defined standard, or the like. For example, controller 805 can determine, according to a user-defined standard, whether to use all channels or partial channels based on tasks, e.g., image reconstruction or image learning.

Multiplexer 814 can be coupled to selector 813 and decompressor 812 and have circuitry configured to multiplex, according to the control signal, the compressed representation among them. For example, in a case that image 801 is to be applied to semantic segmentation, the control signal can indicate to use a part of compressed channels. Multiplexer 814 can output, according to the control signal, the received (e.g., received from multiplexer 814 or read from the memory) compressed representation to selector 813. In a case that image is to be reconstructed, the control signal can indicate to use all compressed channels. Multiplexer 814 can output, according to the control signal, the received (e.g., received from multiplexer 814 or read from the memory) the compressed representation to decompressor 812.

Selector 813 can receive the compressed representation and have circuitry configured to select a part of compressed channels from the compressed representation. In some embodiments, selector 813 can select C top compressed channels with largest entropies or feature value variances from the compressed representation. The number C can be determined based on the entropy distribution (e.g., distribution 500 of FIG. 5) or feature value variance distribution over the compressed channels. In some embodiments, selector 813 can have circuitry configured to execute a selection neural network that can be trained to select a plurality of compressed channels from the compressed representation.

Learning module 817 can be coupled with selector 813 and have circuitry configured to perform a learning on the selected compressed channels. In some embodiments, learning module 817 can have circuitry configured to execute a learning neural network (e.g., neural network 100 of FIG. 1), e.g., a CNN, a RNN, or the like. The learning neural network can be pre-trained to perform a CV task, e.g., image recognition, image classification, object detection, semantic segmentation, or the like. For example, as shown in FIG. 4, the learning neural network can perform an image recognition and output a plurality of possible evaluation items with respective probabilities (e.g., “sheep 80%”, “cat 10%”, or the like).

Decompressor 812 can have circuitry configured to perform a reconstruction on the compressed representation. In some embodiments, decompressor 812 can have circuitry configured to execute a reconstruction neural network (e.g., neural network 100 of FIG. 1), e.g., a CNN, a RNN, or the like. The reconstruction neural network can perform a NN-based reconstruction on compressed representation, and generate a reconstructed image. The reconstructed image can be the same RGB image as or different image from the original image 801.

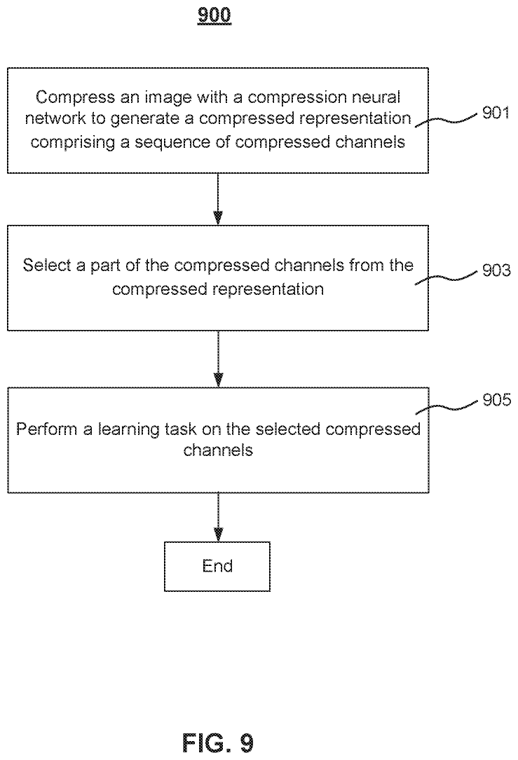

FIG. 9 illustrates a flowchart of an exemplary method 900 for machine learning from partial compressed representation, according to some embodiments of the present disclosure. Method 900 can be implemented, at least partially, by neural network accelerator 200 of FIGS. 2A and 2C, core 202 of FIGS. 2A-2B, cloud system 230 of FIG. 2C, machine learning system 600 of FIG. 6, machine learning system 750 of FIG. 7, or machine learning system 850 of FIG. 8. Moreover, method 900 can also be implemented by a computer program product, embodied in a computer-readable medium, including computer-executable instructions, such as program code, executed by computers. In some embodiments, a host unit (e.g., host unit 220 of FIG. 2A or 2C) may compile software code for generating instructions for providing to one or more accelerators to perform method 900.

As shown in FIG. 9, at step 901, method 900 can include compressing an image with a compression neural network to generate a compressed representation (e.g., compressed representation 403 of FIG. 4). The compressed representation can include a sequence of compressed channels. Each compressed channel can include a plurality of signals. The compression neural network can be a trained compression CNN, RNN, or the like. The compression step 901 can be performed by a compressor (e.g., compressor 602 of FIG. 6, compressor 702 of FIG. 7, or compressor 802 of FIG. 8).

At step 903, method 900 can include selecting a part of the compressed channels from the compressed representation. In some embodiments, selecting a part of the compressed channels can include selecting a plurality of top compressed channels with largest entropies or feature value variances from the compressed representation. The number of selected channels can be determined based on the entropy distribution or feature value variance distribution over the compressed channels. In some embodiments, selecting a part of the compressed channels can include selecting, with a selection neural network, a plurality of compressed channels from the compressed representation. The selection neural network can be pre-trained to achieve good performance during learning with the selected channels. The selection step 903 can be performed by a selector (e.g., selector 603 of FIG. 6, selector 703 of FIG. 7, or selector 813 of FIG. 8).

At step 905, method 900 can include performing a learning task on the selected compressed channels. The learning task can include both training or inference of a learning neural network and can be applied to various CV tasks, including, but not being limited to, image recognition, image classification, object detection, semantic segmentation, or the like. The learning step 905 can be performed by a learning module (e.g., learning module 604 of FIG. 6, learning module 717 of FIG. 7, or learning module 817 of FIG. 8).

In some embodiments, method 900 can include decompressing the compressed representation to generate a decompressed image. The decompression step can be performed by a decompressor (e.g., decompressor 712 of FIG. 7 or decompressor 812 of FIG. 8). Moreover, method 900 can also include determining whether the learning task or a reconstruction task is to be performed. If the learning task is determined to be performed, the part of the compressed channels can be selected from the compressed representation. If the reconstruction task is determined to be performed, the compressed representation can be decompressed to generate the decompressed image. For example, with reference to FIG. 7, controller 705 can generate a control signal based on tasks, e.g., image reconstruction or image learning. The control signal can indicate whether to use all compressed channels or partial compressed channels. Controller 705 can send the control signal to multiplexers 704 and 714. Multiplexers 704 can output, according to the control signal, the compressed representation or the selected compressed channels. Multiplexer 714 can output, according to the control signal, the compressed representation to the decompressor or the selected compressed channels to the learning module.

It is appreciated that the embodiments disclosed herein can be used in various application environments, such as artificial intelligence (AI) training and inference, database and big data analytic acceleration, video compression and decompression, and the like.

Embodiments of the present disclosure can be applied to many products. For example, some embodiments of the present disclosure can be applied to Ali-NPU (e.g., Hanguang NPU), Ali-Cloud, Ali PIM-AI (Processor-in Memory for AI), Ali-DPU (Database Acceleration Unit), Ali-AI platform, Ali-Data Center AI Inference Chip, IoT Edge AI Chip, GPU, TPU, or the like.

The embodiments may further be described using the following clauses:

1. A machine learning system, comprising:

a compressor having circuitry configured to use a compression neural network to compress an image into a compressed representation, the compressed representation comprising a sequence of compressed channels;

a selector having circuitry configured to select a part of the compressed channels from the compressed representation; and

a learning module having circuitry configured to perform a learning task on the selected compressed channels.

2. The machine learning system of clause 1, further comprising:

a first multiplexer communicatively coupled with the compressor and the selector and having circuitry configured to multiplex the compressed representation from the compressor and the selected compressed channels from the selector.

3. The machine learning system of clause 2, further comprising:

a decompressor having circuitry configured to decompress the compressed representation to generate a decompressed image; and

a second multiplexer having circuitry configured to receive the compressed representation or the selected compressed channels, the second multiplexer being communicatively coupled with the learning module and decompressor and having circuitry configured to output the compressed representation to the decompressor or the selected compressed channels to the learning module.

4. The machine learning system of clause 3, further comprising:

a transmitter communicatively coupled with the first multiplexer and configured to transmit the compressed representation or the selected compressed channels; and

a receiver communicatively coupled with the second multiplexer and configured to receive the compressed representation or the selected compressed channels from the transmitter and provide the received compressed representation or selected compressed channels to the second multiplexer.

5. The machine learning system of clause 3, further comprising:

a memory for storing the compressed representation or the selected compressed channels from the first multiplexer, wherein the second multiplexer has circuitry configured to read the stored compressed representation or selected compressed channels from the memory.

6. The machine learning system of any one of clauses 3-5, further comprising:

a controller communicatively coupled with the first multiplexer and the second multiplexer and having circuitry configured to send a control signal to the first multiplexer and the second multiplexer,

wherein the first multiplexer has circuitry configured to output, according to the control signal, the compressed representation or the selected compressed channels, and the second multiplexer has circuitry configured to output, according to the control signal, the compressed representation to the decompressor or the selected compressed channels to the learning module.

7. The machine learning system of clause 1, further comprising:

a decompressor having circuitry configured to decompress the compressed representation to generate a decompressed image;

a multiplexer having circuitry configured to receive the compressed representation, the multiplexer being communicatively coupled with the selector and the decompressor and having circuitry configured to output the compressed representation to the selector or the decompressor,

wherein the selector is communicatively coupled with the learning module.

8. The machine learning system of clause 7, further comprising:

a transmitter communicatively coupled with the compressor and configured to transmit the compressed representation; and

a receiver communicatively coupled with the multiplexer and configured to receive the compressed representation from the transmitter and provide the received compressed representation to the multiplexer.

9. The machine learning system of clause 7, further comprising:

a memory for storing the compressed representation from the compressor, wherein the multiplexer is configured to read the stored compressed representation from the memory.

10. The machine learning system of any one of clauses 7-9, further comprising:

a controller communicatively coupled with the multiplexer and having circuitry configured to send a control signal to the multiplexer.

11. The machine learning system of any one of clauses 1-10, wherein the selector has circuitry configured to select a plurality of top compressed channels with largest entropies or feature value variances.
12. The machine learning system of any one of clauses 1-10, wherein the selector has circuitry configured to use a selection neural network to select a plurality of compressed channels.
13. A method for machine learning, comprising:

compressing an image with a compression neural network to generate a compressed representation comprising a sequence of compressed channels;

selecting a part of the compressed channels from the compressed representation; and

performing a learning task on the selected compressed channels.

14. The method of clause 13, further comprising:

decompressing the compressed representation to generate a decompressed image.

15. The method of clause 14, further comprising:

determining whether the learning task or a reconstruction task is to be performed;

in response to the learning task being determined to be performed, selecting the part of the compressed channels from the compressed representation; and

in response to the reconstruction task being determined to be performed, decompressing the compressed representation to generate the decompressed image.

16. The method of any one of clauses 13-15, wherein selecting the part of the compressed channels comprises:

selecting a plurality of top compressed channels with largest entropies or feature value variances from the compressed representation.

17. The method of any one of clauses 13-15, wherein selecting the part of the compressed channels comprises:

selecting, with a selection neural network, a plurality of compressed channels from the compressed representation.

18. An apparatus for machine learning, comprising:

at least one memory for storing instructions; and

at least one processor configured to execute the instructions to cause the apparatus to perform:
compressing an image with a neural network to generate a compressed representation comprising a plurality of compressed channels;
selecting a part of the compressed channels from the compressed representation; and
performing a learning task on the selected compressed channels.
   19. The apparatus of clause 18, wherein the at least one processor is configured to execute the instructions to cause the apparatus to perform:

decompressing the compressed representation to generate a decompressed image.

20. The apparatus of clause 19, wherein the at least one processor is configured to execute the instructions to cause the apparatus to perform:

determining whether the learning task or a reconstruction task is to be performed;

in response to the learning task being determined to be performed, selecting the part of the compressed channels from the compressed representation; and

in response to the reconstruction task being determined to be performed, decompressing the compressed representation to generate the decompressed image.

21. The apparatus of any one of clauses 18-20, wherein the at least one processor is configured to execute the instructions to cause the apparatus to perform:

selecting a plurality of top compressed channels with largest entropies or feature value variances from the compressed representation.

22. The apparatus of any one of clauses 18-20, wherein the at least one processor is configured to execute the instructions to cause the apparatus to perform:

selecting, with a selection neural network, a plurality of compressed channels from the compressed representation.

23. A non-transitory computer readable storage medium storing a set of instructions that are executable by one or more processing devices to cause a computer to perform:

compressing an image with a neural network to generate a compressed representation comprising a plurality of compressed channels;

selecting a part of the compressed channels from the compressed representation; and

performing a learning task on the selected compressed channels.

24. The non-transitory computer readable storage medium of clause 23, wherein the set of instructions are executable by the one or more processing devices to cause the computer to perform:

decompressing the compressed representation to generate a decompressed image.

25. The non-transitory computer readable storage medium of clause 24, wherein the set of instructions are executable by the one or more processing devices to cause the computer to perform:

determining whether the learning task or a reconstruction task is to be performed;

in response to the learning task being determined to be performed, selecting the part of the compressed channels from the compressed representation; and

in response to the reconstruction task being determined to be performed, decompressing the compressed representation to generate the decompressed image.

26. The non-transitory computer readable storage medium of any one of clauses 23-25, wherein the set of instructions are executable by the one or more processing devices to cause the computer to perform:

selecting a plurality of top compressed channels with largest entropies or feature value variances from the compressed representation.

27. The non-transitory computer readable storage medium of any one of clauses 23-25, wherein the set of instructions are executable by the one or more processing devices to cause the computer to perform:

selecting, with a selection neural network, a plurality of compressed channels from the compressed representation.

The various example embodiments described herein are described in the general context of method steps or processes, which may be implemented in one aspect by a computer program product, embodied in a computer readable medium, including computer-executable instructions, such as program code, executed by computers in networked environments. A computer readable medium may include removeable and nonremovable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the present disclosure are apparent from the detailed specification, and thus, it is intended that the appended claims cover all systems and methods falling within the true spirit and scope of the present disclosure. As used herein, the indefinite articles “a” and “an” mean “one or more.” Further, since numerous modifications and variances will readily occur from studying the present disclosure, it is not desired to limit the present disclosure to the exact reconstruction and operation illustrated and described, and accordingly, all suitable modifications and equivalents may be resorted to, falling within the scope of the present disclosure.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A machine learning system, comprising:
a compressor having circuitry configured to use a compression neural network to compress an image into a compressed representation, the compressed representation comprising a sequence of compressed channels;
a selector having circuitry configured to select a part of the compressed channels from the compressed representation; and
a learning module having circuitry configured to perform a learning task on the selected compressed channels.

2. The machine learning system of claim 1, further comprising:
a first multiplexer communicatively coupled with the compressor and the selector and having circuitry configured to multiplex the compressed representation from the compressor and the selected compressed channels from the selector.

3. The machine learning system of claim 2, further comprising:
a decompressor having circuitry configured to decompress the compressed representation to generate a decompressed image; and
a second multiplexer having circuitry configured to receive the compressed representation or the selected compressed channels, the second multiplexer being communicatively coupled with the learning module and decompressor and having circuitry configured to output the compressed representation to the decompressor or the selected compressed channels to the learning module.

4. The machine learning system of claim 3, further comprising:
a transmitter communicatively coupled with the first multiplexer and configured to transmit the compressed representation or the selected compressed channels; and
a receiver communicatively coupled with the second multiplexer and configured to receive the compressed representation or the selected compressed channels from the transmitter and provide the received compressed representation or selected compressed channels to the second multiplexer.

5. The machine learning system of claim 3, further comprising:
a memory for storing the compressed representation or the selected compressed channels from the first multiplexer, wherein the second multiplexer has circuitry configured to read the stored compressed representation or selected compressed channels from the memory.

6. The machine learning system of claim 3, further comprising:
a controller communicatively coupled with the first multiplexer and the second multiplexer and having circuitry configured to send a control signal to the first multiplexer and the second multiplexer,
wherein the first multiplexer has circuitry configured to output, according to the control signal, the compressed representation or the selected compressed channels, and the second multiplexer has circuitry configured to output, according to the control signal, the compressed representation to the decompressor or the selected compressed channels to the learning module.

7. The machine learning system of claim 1, further comprising:
a decompressor having circuitry configured to decompress the compressed representation to generate a decompressed image;
a multiplexer having circuitry configured to receive the compressed representation, the multiplexer being communicatively coupled with the selector and the decompressor and having circuitry configured to output the compressed representation to the selector or the decompressor,
wherein the selector is communicatively coupled with the learning module.

8. The machine learning system of claim 7, further comprising:
a transmitter communicatively coupled with the compressor and configured to transmit the compressed representation; and
a receiver communicatively coupled with the multiplexer and configured to receive the compressed representation from the transmitter and provide the received compressed representation to the multiplexer.

9. The machine learning system of claim 7, further comprising:
a memory for storing the compressed representation from the compressor, wherein the multiplexer is configured to read the stored compressed representation from the memory.

10. The machine learning system of claim 7, further comprising:
a controller communicatively coupled with the multiplexer and having circuitry configured to send a control signal to the multiplexer.

11. The machine learning system of claim 1, wherein the selector has circuitry configured to select a plurality of top compressed channels with largest entropies or feature value variances.

12. A method for machine learning, comprising:
compressing an image with a compression neural network to generate a compressed representation comprising a sequence of compressed channels;
selecting a part of the compressed channels from the compressed representation; and
performing a learning task on the selected compressed channels.

13. The method of claim 12, further comprising:
decompressing the compressed representation to generate a decompressed image.

14. The method of claim 13, further comprising:
determining whether the learning task or a reconstruction task is to be performed;
in response to the learning task being determined to be performed, selecting the part of the compressed channels from the compressed representation; and
in response to the reconstruction task being determined to be performed, decompressing the compressed representation to generate the decompressed image.

15. The method of claim 12, wherein selecting the part of the compressed channels comprises:
selecting a plurality of top compressed channels with largest entropies or feature value variances from the compressed representation.

16. An apparatus for machine learning, comprising:
at least one memory for storing instructions; and
at least one processor configured to execute the instructions to cause the apparatus to perform:
compressing an image with a neural network to generate a compressed representation comprising a plurality of compressed channels;
selecting a part of the compressed channels from the compressed representation; and
performing a learning task on the selected compressed channels.

17. The apparatus of claim 16, wherein the at least one processor is configured to execute the instructions to cause the apparatus to perform:
decompressing the compressed representation to generate a decompressed image.

18. The apparatus of claim 17, wherein the at least one processor is configured to execute the instructions to cause the apparatus to perform:
determining whether the learning task or a reconstruction task is to be performed;
in response to the learning task being determined to be performed, selecting the part of the compressed channels from the compressed representation; and
in response to the reconstruction task being determined to be performed, decompressing the compressed representation to generate the decompressed image.

19. The apparatus of claim 16, wherein the at least one processor is configured to execute the instructions to cause the apparatus to perform:
selecting a plurality of top compressed channels with largest entropies or feature value variances from the compressed representation.

20. A non-transitory computer readable storage medium storing a set of instructions that are executable by one or more processing devices to cause a computer to perform:
compressing an image with a neural network to generate a compressed representation comprising a plurality of compressed channels;
selecting a part of the compressed channels from the compressed representation; and
performing a learning task on the selected compressed channels.
